(19) United States
(12) Patent Application Publication
(10) Pub. No.: US 2002/0047416 A1
(43) Pub. Date: Apr. 25, 2002

(54) Electric motor assembly and a method of actuating an electric motor

(76) Inventors: Ricardo Augusto De Facci Oliveira, Caxias do Sul (BR); Fernando Augusto Becker, Porto Alegre (BR)

Correspondence Address: Smith, Gambrell & Russell, LLP, The Beveridge, DeGrandi,, Weilacher & Young Intellectual Property Group, 1850 M Street, N.W., Suite 800, Washington, DC, 20036, US

(21) Appl. No.: 09/854,497

(22) Filed: May 15, 2001

(30) Foreign Application Priority Data
Aug. 24, 2000 (BR) PI 0004569-1

(51) Int. Cl. H02K 7/20

(52) U.S. Cl. 310/112

(57) ABSTRACT

The present invention relates to em electric motor assembly (1) comprising a main electric motor (2) and a coupled electric starter motor (3). The electric starter motor (3) may, for instance, be coupled to the rotation axle (4) of the main electric motor (2). In this way, the electric starter motor (3) will be actuated to accelerate the main motor (2) up to a nominal rotation, after which the main motor (2) will be ready to be actuated, and, since it will already be in motion, the current required for accelerating it up to its nominal power will lie within the ranges permitted by the electricity supply companies In this way, it is possible to actuate a motor having a power rating of, for example, 50 HP, with low current peaks.

The present invention relates to an electric motor assembly and to a method of actuating an electric motor.

### DESCRIPTION OF THE STATE OF THE ART

The prior-art electric motors have their start-up or running electrical current values limited to those permitted by the electricity supply companies. This limitation is for the purpose of preventing high energy peaks that could overload the electrical network, thus causing undesirable consequences, for example damage to electrical equipment. However, this limitation of electrical current values causes an undesirable limitation to the power of the motor.

In order to overcome this problem, higher powered triple-phase motors make use of “delta-star”—type starting switches, compensators, soft-starters or frequency inverters, so that such devices minimize the effects of peaks in the starting current. These devices, however, have the drawback of being very costly.

Moreover, in conventional monophase motors, and mainly in rural areas, these devices cannot be used, so the maximum power ratings of such motors are generally limited to between 5 HP and 15 HP, due to the electrical current limitations imposed by the electricity supply companies. Thus, these monophase motors have the drawback that their power is limited by the permitted ranges of starting currents.

### OBJECTIVES OF THE INVENTION

The first objective of the present invention is to provide an electric motor assembly, the actuation of which uses starting current within the ranges permitted by the electricity supply companies.

Another objective is to provide an electric motor assembly that involves manufacturing costs lower than those of prior-art motors.

The third objective is to provide an electric motor assembly with a maximum power that is not limited by the current ranges determined by the electricity supply companies.

The fourth objective is to provide a method for actuating a high-powered electric motor that uses electrical current within the ranges permitted by the electricity supply companies.

### BRIEF DESCRIPTION OF THE INVENTION

The present invention achieves these objectives by means of an electric motor assembly comprising a main electric motor and a coupled electric starter motor suitable for starting the main motor. The electric starter motor has less power than the main motor, preferably in the range 5 HP to 15 HP, due to the fact that the current utilized by this electric starter motor is limited to the current permitted by the electricity supply companies for a direct start. In addition, in one possible embodiment, the power value of the electric starter motor can reach approximately 15 HP. On the other hand, the power value of the main electric motor is higher and can reach about 50 HP or more, as determined by the electricity supply companies. In this way, in order to avoid high current peaks, which occur upon starting a highpowered motor, such as the aforementioned main electric motor, an electric starter motor coupled to the latter is used, which, as already stated, has less power, the current peaks not exceeding the ranges permitted by the electricity supply companies. Thus, before starting the main electric motor, its rotation is accelerated by the starter motor up to its nominal rotation without load (maximum rotation of the synchronous rotation), so that, when the main electric power is actuated, it is already rotating, which reduces the intensity of current required for the start-up, maintaining the current peaks within the ranges permitted by the electricity supply companies.

The present invention further relates to a method of actuating an electric motor, which comprises a first step consisting of actuating the electric starter motor whose operation is coupled to a main electric motor. These motors are preferably those defined in the preceding paragraph, without the method of the present invention being limited to the utilization of motors with the stated powers. The next step consists of switching off the electric starter motor when the latter reaches its nominal rotation. At this step, the main electric motor is also actuated, and, in a first embodiment, this may be done simultaneously with the switching off of the starter motor, or in other embodiments, just before or after the starter motor is switched off.

Thus, the present invention allows higher powers to be obtained, without, in the case of triple-phase motors, the need for expensive devices such as soft-starters or frequency inverters to minimize starting current peaks.

### DESCRIPTION OF THE DRAWINGS

The present invention will now be described in greater detail with reference to an embodiment represented in the drawing.

FIG. 1 shows a view of an electric motor of the prior art;

FIG. 2 shows a view of an electric motor assembly according to the present invention.

### DETAILED DESCRIPTION OF THE FIGURES

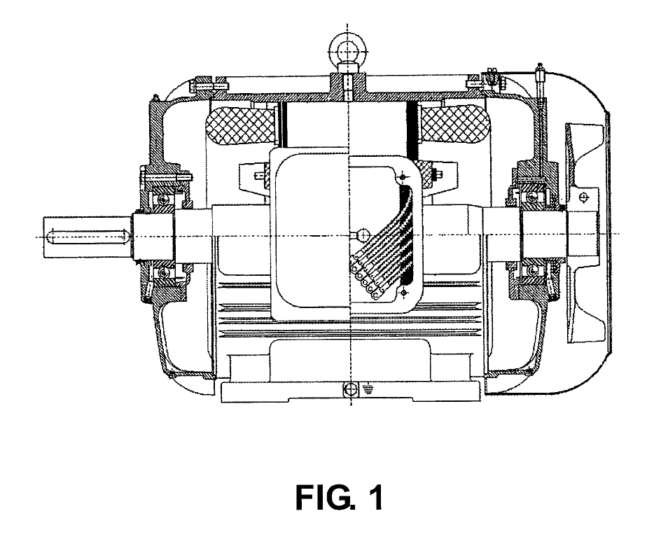

FIG. 1 shows an embodiment of an electric motor of the state of the art.

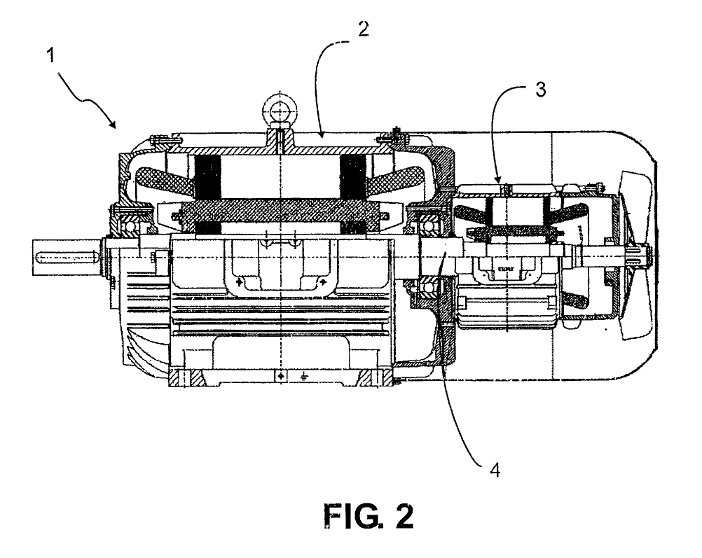

FIG. 2 illustrates one of the possible embodiments of the electric motor assembly 1 of the present invention, where the electric starter motor 3 whose operation is coupled to the main electric motor 2 by means of the rotation axle 4. This coupling between the motors does not need to be on the same axle; in other embodiments, it may be on different axles and may be effected by means of pulleys, gears, among other coupling means.

The electric starter motor 3 is suitable for starting the main electric motor 2. In addition, the electric starter motor 3 has a power rating of up to 15 HP, so that upon its actuation the current peaks reached will lie within the ranges permitted by the electricity supply companies. On the other hand, the power of the main electric motor 2 is 50 HP. In other embodiments, the present invention could have power values different from those mentioned above.

The start of the main electric motor 2 is effected by actuating the electric starter motor 3, which, by means of the rotation axle 4, transmits mechanical energy to the former, so as to accelerate its rotation. As already mentioned above, the value of the current peak involved in this actuation is within the ranges permitted by the electricity supply companies, since only the low-powered motor 3 is actuated. This acceleration increases the rotation of the main electric motor 2 until the nominal rotation of the electric starter motor 3 is reached. At this point, the motor 2 may already be actuated, and, since it is already at its nominal rotation, the current peak that would occur if the motor were actuated from rest is prevented, the current remaining within the permitted ranges. In this way, it is possible to actuate a motor with a power of, say, 50 HP with low current peaks. The switching-off of the starter motor is effected, in this embodiment, simultaneously with the actuation of the main motor. In other embodiments, one can also switch it off just before or after the main motor is actuated.

In another embodiment, not shown, one may use two motors having the same power, coupled by means of any of the above-described ways. One of the motors is actuated, while the other is off, so that both accelerate until they reach their nominal rotation. When the nominal rotation is reached, the second motor is then started, and the two motors begin to work together. In this way, one achieves high power with a peak of actuation current at the levels permitted by the electricity supply companies. In addition, the starting of the main electric motor may be carried out just before or after the latter has reached its nominal rotation.

Having described the preferable embodiments of the invention, it should be understood that the scope of the present invention embraces other possible variations, limited only by the content of the accompanying claims.

1. An electric motor assembly (1) characterized by comprising a main electric motor (2) and an electric starter motor (3) whose operation is coupled, so that the electric starter motor (3) is suitable for starting the main electric motor.

2. An assembly according to claim 1, characterized in that the electric starter motor (3) has less power than the main electric motor (2).

3. An assembly according to claim 1, characterized in that the electric starter motor (3) has the same power as the main electric motor (2)

4. An assembly according to claim 3, characterized in that the electric starter motor (3) and main electric motor (2) have power ranging from 5 HP to 15 HP.

5. An assembly according to any one of claims 1 or 2, characterized in that the electric starter motor (3) has power ranging from 5 HP to 15 HP.

6. An assembly according to claim 5, characterized in that the electric starter motor (3) has power of approximately 15 HP.

7. An assembly according to any one of claims 1, 2, 5, or 6, characterized in that the main electric motor (2) has power of approximately 50 HP.

8. An assembly according to any one of claims 1-7, characterized in that the electric starter motor (3) is coupled to the main electric motor (2) by means of a rotation axle (4).

9. An assembly according to any one of claim 1-7, characterized in that the electric starter motor is coupled to the main electric motor by means of a pulley.

10. An assembly according to any one of claims 1-7, characterized in that the electric starter motor is coupled to the main electric motor by means of a gear.

11. A method of starting an electric motor, characterized by comprising the steps of actuating an electric starter motor whose operation is coupled to a main electric motor, while the main electric motor is maintained off until the nominal rotation of the main motor is reached, and then the main motor is started.

12. A method according to claim 11, characterized in that it further includes the step of switching off the electric starter motor, when the main electric motor reaches the nominal rotation of the electric starter motor, and actuating the main electric motor.

13. A method according to claim 12, characterized in that the electric starter motor is switched of simultaneously with the actuation of the main electric motor.

14. A method according to claim 12, characterized in that the electric starter motor is switched off just before the main electric motor is actuated.

15. A method according to claim 12, characterized in that the electric starter motor is switched off just after actuation of the main electric motor.

16. A method according to any one of claims 11-15, characterized in that the main electric motor is actuated just before reaching the nominal rotation.

17. A method according to any one of claims 11-15, characterized in that the main electric motor is actuated right after reaching the nominal rotation.
